(19) United States
(12) Patent Application Publication
(10) Pub. No.: US 2006/0223737 A1
(43) Pub. Date: Oct. 5, 2006

(54) Foaming O/W emulsion and use thereof in cosmetics

(75) Inventors: Laurence Sebillotte-Arnaud, L'Hay les Roses (FR); Odile Aubrun, Paris (FR); Armelle De Salvert, Paris (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/375,166

(22) Filed: Mar. 15, 2006

Related U.S. Application Data
(60) Provisional application No. 60/681,153, filed on May 16, 2005.

(30) Foreign Application Priority Data
Mar. 25, 2005 (FR) 0550781

(51) Int. Cl. C11D 17/00

(52) U.S. Cl. 510/407

(57) ABSTRACT

Foaming composition for topical application in the form of an oil-in-water emulsion, where the size of the droplets of the oily phase D[4,3] is less than or equal to 4 μm, the oily phase is present in an amount of at least 30% by weight, the composition containing an emulsifying system with an HLB value ranging from 8 to 18, present in an amount of at least 2% by weight relative to the total weight of the composition, and a foaming system comprising at least one anionic surfactant chosen from alkyl glycol carboxylic acids of formula (I) and salts thereof.

### REFERENCE TO PRIOR APPLICATIONS

This application claims priority to U.S. provisional application 60/681,153 filed May 16, 2005, and to French patent application 0550781 filed Mar. 25, 2005, both incorporated herein by reference.

### FIELD OF THE INVENTION

The present invention relates to a foaming composition. Preferably, this composition is suitable for topical application, especially cosmetic and/or dermatological application, and is in the form of an oil-rich oil-in-water emulsion, which may be obtained by phase inversion. The invention also relates to the use of the described compositions in cosmetics and dermatology.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Cleansing of the skin is very important for facial care, and should be as efficient as possible since greasy residues such as excess sebum, residues of the cosmetic products used daily and makeup products, especially “waterproof” products, accumulate in the folds of the skin and can block the skin pores and lead to the formation of spots.

In the field of cleansing, it is known practice to use foaming aqueous gels. Their cleansing action is provided by the Surfactants they contain, these surfactants placing in suspension the greasy residues and the pigments of makeup products. However, these gels often have the drawback of leaving the skin dry and of giving sensations of tautness. Furthermore, their makeup-removing power is not always sufficient.

Moreover, in the field of makeup removal, it is known practice to use milks or creams (non-foaming products). These products are more comfortable than aqueous gels, but often have the drawback of leaving an excessively greasy residue after application to the skin, and it is then necessary to use a tonic to remove the surplus residual fatty substance.

As a result, it is sought to make two-in-one products, which are both foaming and cleansing while at the same time providing a care function and/or which remove makeup without leaving an excessively greasy residue.

One of the means for providing this care function in foaming products is to incorporate oil therein and thus to prepare emulsions. Products of this type already exist, and they may be used as care cleansing products both for the face and for the body since they leave a small amount of oil on the surface of the skin, or alternatively as rinse-off makeup-removing products. However, these products are not satisfactory as regards the foam initiation and/or the volume of foam obtained since the presence of oils hinders good foam development. In addition, the amount of oils therein is generally limited precisely by the problems posed by the presence of oil as regards foam development.

Thus, document FR-A-2 733 417 describes foaming oil-in-water emulsions in the form of creams, comprising foaming nonionic surfactants, oils with given solubility parameters, and crosslinked polymers, especially vinyl polymers, as gelling agents. However, these compositions have the drawback of not giving a satisfactory foam, and especially of having poor foam initiation and giving a low volume of foam.

### OBJECTS OF THE INVENTION

There is thus still a need to make products which, while being just as gentle as non-foaming products such as creams or milks, have good foaming properties with a good quality of foam, while at the same time having good tolerance and containing a large amount of oil.

### SUMMARY OF THE INVENTION

It has been found, surprisingly, that the problem posed is addressed by using an emulsion having small-sized droplets of oily phase, containing a combination of at least one alkyl polyglucoside and of at least one alkyl glycol carboxylic acid, as foaming surfactants, this emulsion being rich in oils and possibly being obtained especially by means of the phase inversion temperature. The compositions obtained have better foam qualities than those of the prior art and good tolerance properties.

Thus, the compositions obtained are very gentle and can be appreciated by any skin type and in particular by dry skin and sensitive skin.

### DETAILED DESCRIPTION OF THE PREFERRED EMBODIMENTS

One subject of the present invention is a foaming composition, preferably suitable for topical application, in the form of an oil-in-water emulsion, the composition comprising an oily phase dispersed in an aqueous phase, preferably wherein:

the size of the droplets of the oily phase D[4,3] is less than or equal to 4 μm, and/or

the oily phase (A) is present in an amount of at least 30% by weight relative to the total weight of the composition, and/or in that the composition comprises:

an emulsifying system (B) with an HLB value ranging from 8 to 18, present in an amount of at least 2% by weight relative to the total weight of the composition, and/or

a foaming system (C) comprising at least one foaming surfactant chosen from alkyl glycol carboxylic acids and salts thereof, of formula (I) below:
R₁—CHOH—CH₂—O—COO⁻X⁺ (I)
in which R₁ denotes a saturated or unsaturated, linear or branched alkyl radical containing from 8 to 30 carbon atoms, and X denotes hydrogen or a mineral or organic cation, and/or

the oily phase (A)/foaming system (C) weight ratio ranging from 1.5 to 12.

Since the compositon is preferably intended for topical application, the composition of the invention preferably contains a physiologically acceptable medium. The term “physiologically acceptable medium” means a medium that is suitable for topical application to the skin or the integuments, i.e. compatible with the skin, mucous membranes, the lips, the eyelashes, the eyes, the hair and the nails. This composition may especially constitute a cosmetic or dermatological composition.

In the present patent application, the term “oily phase” means the phase containing lipophilic compounds, which are especially oils (lipophilic constituents that are liquid at room temperature), gums, pastes and waxes. They are, for example, triglycerides, hydrocarbons, esters, ethers, silicones, as described later, and any lipophilic additive possibly present, preferably provided that these compounds do not harm the formation of the foam. The emulsifiers and coemulsifiers of the emulsifying system do not form part of the oily phase (A) as defined above.

The O/W emulsions according to the invention comprise an oily phase (or lipophilic phase) dispersed in an aqueous phase. They are preferably obtained via the phase inversion temperature technique, and are preferably characterized by:
their viscosity: they are mainly creams,
their pH, which ranges from 5 to 10.5 and preferably from 5 to 9, and/or
the small size of the droplets of the oily phase, of less than or equal to 4 μm, and/or
their stability: after two months at 45° C., no macroscopic phase separation or change in texture such as the appearance of grains takes place, and/or
their high makeup-removing power.

The principle of emulsification by means of the phase inversion temperature (or PIT) is, in its principle, well known to those skilled in the art; it was described in 1968 by K. Shinoda (J. Chem. Soc. Jpn., 1968, 89, 435). It has been shown that this emulsification technique makes it possible to obtain stable fine emulsions (K. Shinoda and H. Saito, J. Colloid Interface Sci., 1969, 30, 258). This technique was applied in cosmetics as early as 1972 by Mitsui et al. (“Application of the phase-inversion-temperature method to the emulsification of cosmetics”; T. Mitsui, Y. Machida and F. Harusawa, American Cosmet. Perfum., 1972, 87, 33).

The principle of this technique is as follows: a mixture of an aqueous phase and an oily phase is prepared and is brought to a temperature above the PIT temperature, the phase inversion temperature of the system, which is the temperature at which the equilibrium between the hydrophilic and lipophilic properties of the emulsifier(s) used is reached; at elevated temperature, i.e. above the phase inversion temperature (>PIT), the emulsion is of water-in-oil type, and, during its cooling, this emulsion inverts at the phase inversion temperature, to become an emulsion of oil-in-water type, and in doing so by passing previously through a state of microemulsion. This process allows emulsions with a diameter of less than 4 μm to be readily obtained.

Emulsions obtained according to the invention, despite the large amount of oils they contain, are preferably stable. The term “stable composition” means a composition that remains macroscopically uniform after 2 months at 45° C. Such stability means that no macroscopic phase separation or change in texture, such as the appearance of grains, takes place after this time interval.

The compositions according to the invention may be in the form of opaque to translucent, more or less thick creams, and they may or may not flow under their own weight depending on their viscosity. The viscosity, measured at 25° C. with a Rheomat 180 viscometer at 200 rpm (revolutions per minute), is greater than or equal to 1 Pa·s. The Rheomat 180 machine is equipped with a different spindle depending on the viscosity, for example a No. 3 spindle for the viscosity range from 0.2 to 4 Pa·s and a No. 4 spindle for the range of viscosities greater than 2 Pa·s. When measured under the conditions indicated above, the viscosity of the compositions of the invention may range, for example, from 1 to 200 Pa·s and preferably from 5 to 180 Pa·s. This viscosity is generally measured 10 minutes after switching on the rotation of the spindle.

The mean size of the droplets of oily phase and their polydispersity are measured, for example, by light scattering using a Mastersizer 2000 granulometer (sold by Malvern Instruments). These measurements are performed on the emulsion diluted in a solution of SDS (sodium dodecyl sulfate) at 1% in water. The mean volume diameter D[4,3] (μm) is determined by means of software (see Operators Guide, Malvern Instruments, December 1998, pp. 61 to 67).

The mean size D[4,3] (μm) of the droplets of oily phase of the composition of the invention is less than or equal to 4 μm and ranges especially from 0.09 μm to 4 μm, more particularly from 0.1 μm to 2 μm and preferably from 0.1 μm to 1 μm.

The polydispersity is defined herein by the absolute deviation relative to the median or “uniformity”. This value should be less than 1.

Foaming System

In the composition according to the invention, the weight ratio of the amount of oily phase (A) to the amount of foaming system (C) preferably ranges from 1.5 to 12 and more preferably from 4 to 10.

The term “foaming system” means all of the foaming surfactants. The foaming system (C) comprises at least one anionic surfactant chosen from alkyl glycol carboxylic acids and salts thereof. This system may comprise only one or more anionic surfactants chosen from alkyl glycol carboxylic acids and salts thereof, or it may comprise a mixture of one or more surfactants of this type and of other foaming surfactants.

Foaming surfactants are generally hydrophilic and thus present in the aqueous phase.

Alkyl Glycol Carboxylic Acids

Alkyl glycol carboxylic acids (or 2-(2-hydroxyalkyloxyacetic) acids) and salts thereof include foaming surfactants of formula (I) below:
R₁—CHOH—CH₂—O—COO⁻X⁺ (I)
in which R₁ denotes a saturated or unsaturated, linear or branched alkyl radical containing from 8 to 30 carbon atoms, and X denotes hydrogen or a mineral or organic cation such as those derived from an alkali metal (for example Na⁺ or K⁺), NH₄⁺, ammoniums derived from basic amino acids such as lysine, arginine or sarcosine, or alternatively amino alcohols such as monoethanolamine, diethanolamine, triethanolamine, glucamine, N-methylglucamine or 3-amino-1,2-propanediol.

The 2-hydroxyalkylcarboxylic acids that are preferred according to the present invention are compounds of formula (I) in which R₁ more particularly denotes a saturated or unsaturated, linear or branched alkyl radical containing from 8 to 18 carbon atoms.

Among the surfactants of formula (I), mention may be made especially of sodium lauryl glycol carboxylate, sold under the names Beaulight Shaa® or Beaulight LCA-25N® by the company Sanyo, or its corresponding acid form sold under the name Beaulight Shaa (Acid Form)® by the company Sanyo.

The amount (as active material) of anionic surfactants of alkyl glycol carboxylic type may range, for example, from 0.5% to 20% by weight, preferably from 1% to 15% by weight and better still from 2% to 10% by weight relative to the total weight of the composition.

Other Foaming Surfactants

The composition may contain other foaming surfactants, which may be chosen from nonionic, amphoteric or zwitterionic, anionic and cationic foaming surfactants.

The composition may contain only anionic surfactants of alkyl glycol carboxylic type, or alternatively it may contain a mixture of foaming surfactants including anionic surfactants of alkyl glycol carboxylic type. The total amount of foaming surfactants (as active material) may range, for example, from 0.5% to 20% by weight, preferably from 1% to 15% by weight and better still from 5% to 15% by weight relative to the total weight of the composition.

As nonionic foaming surfactants, the composition may contain, for example, one or more nonionic surfactants chosen from alkyl polyglucosides (APG), maltose esters, polyglycerolated fatty alcohols, and glucamine derivatives, for instance 2-ethylhexyloxycarbonyl-N-methylglucamine, and mixtures thereof.

Alkylpolyglucosides that are preferably used include those containing an alkyl group containing from 6 to 30 carbon atoms and preferably from 8 to 16 carbon atoms, and containing a hydrophilic group (glucoside) preferably comprising 1.2 to 3 glucoside units. Examples of alkylpolyglucosides that may be mentioned include decylglucoside (Alkyl-C9/C11-polyglucoside (1.4)) for instance the product sold under the name Mydol 10® by the company Kao Chemicals, the product sold under the name Plantaren 2000 UP® by the company Cognis, and the product sold under the name Oramix NS 10® by the company SEPPIC; caprylyl/capryl glucoside, for instance the product sold under the name Oramix CG 110® by the company SEPPIC; lauryl glucoside, for instance the products sold under the names Plantaren 1200 N® and Plantacare 1200® by the company Cognis; cocoglucoside, for instance the product sold under the name Plantacare 818/UP® by the company Cognis; and mixtures thereof.

The maltose derivatives are, for example, those described in document EP-A-566 438, such as O-octanoyl-6′-D-maltose or O-dodecanoyl-6′-D-maltose described in document FR-A-2 739 556.

An example of a polyglycerolated fatty alcohol that may be mentioned is polyglycerolated (3.5 mol of glycerol) dodecanediol, this product being sold under the name Chimexane NF® by the company Chimex.

The amphoteric and zwitterionic foaming surfactants may be chosen, for example, from betaine derivatives including amidopropylbetaines, amphoacetates and hydroxylsultaines, and mixtures thereof.

Examples of betaine derivatives that may be mentioned include, for example, cocobetaine, for instance the product sold under the name Dehyton AB-30® by the company Cognis; laurylbetaine, for instance the product sold under the name Genagen KB® by the company Clariant; oxyethylenated (10 EO) laurylbetaine, for instance the product sold under the name Lauryl ether (10 OE) betaine® by the company Shin Nihon Rica; oxyethylenated (10 EO) stearylbetaine, for instance the product sold under the name Stearyl ether (10 OE) betaine® by the company Shin Nihon Rica; the cocamidopropyl betaine sold, for example, under the name Velvetex BK 35® by the company Cognis; the undecylenamidopropyl betaine sold, for example, under the name Amphoram U® by the company Ceca; and mixtures thereof.

Examples of alkyl amphoacetates that may be mentioned include N-disodium N-cocoyl-N-carboxymethoxy-ethyl-N-carboxymethylethylenediamine (CTFA name: disodium cocamphodiacetate), for instance the product sold under the name Miranol C2M Concentrate NP® by the company Rhodia Chimie; N-sodium N-cocoyl-N-hydroxyethyl-N-carboxymethylethylenediamine (CTFA name: sodium cocamphoacetate), and mixtures thereof.

The anionic surfactants may be chosen, for example, from soaps (alkali metal salts of fatty acids), amino acid derivatives, for instance acylamino acids such as glycinates, amido ether carboxylates, alkyl polyamino carboxylates, alkyl ether sulfates such as sodium laureth sulfates, alkyl sulfonates, isethionates, alkyl methyltaurates, alkyl sulfosuccinates, alkyl sulfoacetates, alkyl phosphates (monoalkyl phosphates or dialkyl phosphates), salts thereof, and mixtures thereof.

According to one preferred embodiment of the invention, the foaming surfactants other than the 2-hydroxyalkylcarboxylic acids are chosen from alkylpolyglucosides, betaine derivatives, alkyl phosphates and alkyl ether sulfates and mixtures thereof.

Emulsifying System

The emulsifying system (B) contains one or more emulsifiers. Emulsifiers, like foaming surfactants, are amphiphilic, i.e. they have a hydrophilic part and a lipophilic part. However, they do not have any foaming property, but they have the particular feature of facilitating the dispersion of two mutually insoluble phases, which foaming surfactants that are detergents do not do. The difference between emulsifiers and foaming surfactants (or detergents) lies in the difference in their HLB (hydrophilic-lipophilic balance) and/or the difference in their fatty chain length. The HLB is the ratio between the hydrophilic part and the lipophilic part in their molecule. This term HLB is well known to those skilled in the art and is described in “The HLB system. A time-saving guide to Emulsifier Selection” (published by ICI Americas Inc: 1984). For emulsifiers, the HLB generally ranges from 3 to 8 for the preparation of W/o emulsions and from 8 to 18 for the preparation of O/W emulsions, whereas foaming surfactants generally have an HLB of greater than 20 and/or a fatty chain containing from 8 to 14 carbon atoms.

The emulsifying system (B) used in the composition according to the invention comprises one or more emulsifiers whose solubility in the oil increases as the temperature increases, these emulsifiers allowing the production of emulsions by means of the phase inversion temperature. The HLB (hydrophilic-lipophilic balance) of the emulsifying system ranges from 8 to 18 and preferably from 10 to 16. The emulsifiers of the emulsifying system may be chosen especially from ethoxylated fatty alcohols, ethoxylated fatty acids, partial glycerides of ethoxylated fatty acids, triglycerides of polyglycerolated fatty acids and ethoxylated derivatives thereof, and mixtures thereof.

The emulsifiers are preferably chosen from ethoxylated fatty alcohols and ethoxylated fatty acids having the formulae (I) and (II) below:
R—O—(CH₂—CH₂O)ₘH (I)
R—COO—(CH₂—CH₂—O)ₘH (II)
in which R is a linear or branched, saturated or unsaturated hydrocarbon-based chain containing from 10 to 24 carbon atoms, and m is an integer ranging from 8 to 50.

Examples of ethoxylated fatty alcohols that may be mentioned include the products of addition of ethylene oxide with lauryl alcohol, especially those containing from 9 to 50 oxyethylene groups and more particularly those containing from 10 to 12 oxyethylene groups (laureth-10 to laureth-12, as the CTFA names); the products of addition of ethylene oxide with behenyl alcohol, especially those containing from 9 to 50 oxyethylene groups (beheneth-9 to beheneth-50, as the CTFA names); the products of addition of ethylene oxide with cetearyl alcohol (mixture of cetyl alcohol and stearyl alcohol), especially those containing from 10 to 30 oxyethylene groups (ceteareth-10 to ceteareth-30, as the CTFA names); the products of addition of ethylene oxide with cetyl alcohol, especially those containing from 10 to 30 oxyethylene groups (ceteth-10 to ceteth-30, as the CTFA names); the products of addition of ethylene oxide with stearyl alcohol, especially those containing from 10 to 30 oxyethylene groups (steareth-10 to steareth-30, as the CTFA names); the products of addition of ethylene oxide with isostearyl alcohol, especially those containing from 10 to 50 oxyethylene groups (isosteareth-10 to isosteareth-50, as the CTFA names); and mixtures thereof.

Examples of ethoxylated fatty acids that may be mentioned include the products of addition of ethylene oxide with lauric acid, palmitic acid, stearic acid or behenic acid, and mixtures thereof, especially those containing from 9 to 50 oxyethylene groups, such as PEG-9 to PEG-50 laurate (as the CTFA names: PEG-9 laurate to PEG-50 laurate); PEG-9 to PEG-50 palmitate (as the CTFA names: PEG-9 palmitate to PEG-50 palmitate); PEG-9 to PEG-50 stearate (as the CTFA names: PEG-9 stearate to PEG-50 stearate); PEG-9 to PEG-50 palmitostearate; PEG-9 to PEG-50 behenate (as the CTFA names: PEG-9 behenate to PEG-50 behenate); and mixtures thereof.

Mixtures of these oxyethylenated derivatives of fatty alcohols and of fatty acids may also be used.

According to one preferred embodiment of the invention, the emulsifying system of the composition of the invention contains as emulsifier at least one ethoxylated fatty alcohol and preferably at least behenyl alcohol.

The emulsifying system may also optionally contain one or more coemulsifiers. Examples of coemulsifiers that may be mentioned include fatty alcohols containing from 12 to 30 carbon atoms, for instance cetyl alcohol, stearyl alcohol or behenyl alcohol; fatty acids containing from 8 to 30 carbon atoms, for instance palmitic acid, stearic acid or behenic acid; fatty esters of glycerol, for instance glyceryl stearate; oxyethylenated derivatives of these fatty alcohols, fatty acids and fatty esters of glycerol, containing 2 to 8 ethylene oxide groups, and mixtures thereof.

The emulsifying system (comprising emulsifiers and coemulsifiers) is generally present in an amount ranging for example from 2% to 20%, preferably from 3% to 16% and better still from 3% to 11% by weight relative to the total weight of the composition.

According to one preferred embodiment of the invention, the emulsifier system (B)/oily phase (A) ratio ranges from 0.04 to 0.2 and preferably from 0.06 to 0.18. As indicated above, the term “oily phase” means all of the constituents that are not hydrophilic and that are different from the emulsifiers or coemulsifiers of the emulsifying system.

Oily Phase

The oily phase, also known as the lipophilic or fatty phase, comprises lipophilic constituents, i.e. oils and other lipophilic substances present in the composition, and also the lipophilic additives that may be present. The oily phase contains at least one oil, especially a cosmetic oil.

The term “oil” means a fatty substance that is liquid at room temperature (20 to 25° C.).

According to one preferred embodiment of the invention, the oily phase of the composition according to the invention comprises at least one oil chosen from hydrocarbon-based oils of mineral or synthetic origin or alkanes, fatty esters and fatty ethers, and mixtures thereof. The term “hydrocarbon-based oil” means any oil predominantly containing carbon and hydrogen atoms, and possibly ester, ether or fluoro groups.

The linear or branched hydrocarbon-based oils (alkanes), of mineral or synthetic origin, may be chosen, for example, from volatile or non-volatile liquid paraffins and derivatives thereof, petroleum jelly, liquid petroleum jelly (mineral oil), perhydrosqualene, polydecenes, isohexadecane, isododecane, and hydrogenated polyisobutene (or hydrogenated isoparaffin) such as Parleam oil.

The fatty esters may be chosen, for example, from those obtained from an alcohol containing a linear or branched, saturated or unsaturated chain containing from 1 to 24 carbon atoms and from a fatty acid containing a linear or branched chain containing from 3 to 24 carbon atoms.

Examples of fatty esters that may be mentioned include 2-ethylhexyl caprate/caprylate (or octyl caprate/caprylate), ethyl laurate, butyl laurate, hexyl laurate, isohexyl laurate, isopropyl laurate, methyl myristate, ethyl myristate, butyl myristate, isobutyl myristate, isopropyl myristate, 2-octyldodecyl myristate, 2-ethylhexyl monococoate (or octyl monococoate), methyl palmitate, ethyl palmitate, isopropyl palmitate, isobutyl palmitate, 2-ethylhexyl palmitate (or octyl palmitate), butyl stearate, isopropyl stearate, isobutyl stearate, 2-ethylhexyl stearate (or octyl stearate), isopropyl isostearate, isocetyl stearate, isostearyl isostearate, 2-ethylhexyl pelargonate (or octyl pelargonate), 2-ethylhexyl hydroxystearate (or octyl hydroxystearate), decyl oleate, diisopropyl adipate, bis(2-ethylhexyl) adipate (or dioctyl adipate), diisocetyl adipate, 2-ethylhexyl succinate (or octyl succinate), diisopropyl sebacate, 2-ethylhexyl malate (or octyl malate), pentaerythrityl caprate/caprylate, 2-ethylhexyl hexanoate (or octyl hexanoate), octyldodecyl octanoate, isodecyl neopentanoate, isostearyl neopentanoate, octyldodecyl neopentanoate, isononyl isononanoate, isotridecyl isononanoate, cetearyl isononanoate, isodecyl isononanoate, isotridecyl isononanoate, lauryl lactate, myristyl lactate, cetyl lactate, myristyl propionate, 2-ethylhexyl 2-ethylhexanoate (or octyl 2-ethylhexanoate), 2-ethylhexyl octanoate (or octyl octanoate), cetyl 2-ethylhexanoate, pentaerythrityl tetraisostearate, isopropyl lauroyl sarcosinate (Eldew SL 205 from the company Unipex), dicaprylyl carbonate (Cetiol CC from the company Cognis) and C12-C15 fatty alkyl benzoates (Finsolv TN from the company Finetex).

A fatty ether that may be mentioned is dicaprylyl ether (Cetiol OE from the company Cognis).

The following oils may also be used in the oily phase (A):

hydrocarbon-based oils of plant origin such as sweet almond oil, avocado oil, castor oil, coriander oil, olive oil, jojoba oil, sesame oil, groundnut oil, grapeseed oil, rapeseed oil, coconut oil, hazelnut oil, shea butter, palm oil, apricot kernel oil, beauty-leaf oil, rice bran oil, corn germ oil, wheatgerm oil, soybean oil, sunflower oil, evening primrose oil, safflower oil, passionflower oil, rye oil, and caprylic/capric acid triglycerides, for instance those sold by the company Stearineries Dubois or those sold under the names Miglyol 810, 812 and 818 by the company Dynamit Nobel;

volatile or non-volatile silicone oils, with the proviso that they do not harm the foam quality, for instance volatile or non-volatile polydimethylsiloxanes (PDMS) with a linear or cyclic silicone chain, which are liquid or pasty at room temperature, especially cyclopolydimethylsiloxanes (cyclomethicones) such as cyclohexasiloxane; polydimethylsiloxanes comprising alkyl, alkoxy or phenyl groups, which are pendent or at the end of a silicone chain, these groups containing from 2 to 24 carbon atoms; phenyl silicones, for instance phenyl trimethicones, phenyl dimethicones, phenyltrimethylsiloxydiphenylsiloxanes, diphenyl dimethicones, diphenylmethyldiphenyltrisiloxanes, 2-phenylethyltrimethyl siloxysilicates and polymethylphenylsiloxanes;

fluoro oils, with the proviso that they do not harm the foam quality, such as partially hydrocarbon-based and/or silicone-based fluoro oils, for instance those described in document JP-A-2 295 912.

In order to obtain a better foam quality, it is advantageous for the oily phase of the composition of the invention to contain one or more oils with a molecular weight of greater than or equal to 360 g/mol, chosen especially from alkanes and fatty acid esters with a molecular weight of greater than or equal to 360 g/mol.

Alkanes that are preferably used include petroleum jelly, liquid petroleum jelly and hydrogenated isoparaffin (or hydrogenated polyisobutene) such as Parleam oil. Liquid petroleum jelly has the advantage of giving a covering foam and good foam initiation.

Examples of fatty esters with a molecular weight of greater than or equal to 360 g/mol that may be mentioned include 2-ethylhexyl palmitate (or octyl palmitate), cetyl 2-ethylhexanoate, 2-octyldodecyl myristate, isocetyl stearate, isostearyl isostearate, 2-ethylhexyl stearate (or octyl stearate), octyldodecyl neopentanoate, cetearyl isononanoate, isodecyl isononanoate, pentaerythrityl tetraisostearate and isotridecyl isononanoate.

Preferably, the composition according to the invention contains one or more fatty esters chosen from those mentioned above. More preferentially, the oily phase of the composition of the invention contains at least one oil chosen from liquid petroleum jelly (mineral oil), 2-ethylhexyl palmitate (or octyl palmitate) and cetyl 2-ethylhexanoate (or cetyl octanoate), and mixtures thereof.

The oily phase may comprise lipophilic additives.

The oily phase is preferably present in an amount of at least 30% by weight, more preferably more than 30% by weight and better still at least 35% by weight relative to the total weight of the composition. The amount of oily phase may range, for example, from 32% to 70% by weight, preferably from 35% to 70%, better still from 35% to 60% by weight and better still from 40% to 60% by weight relative to the total weight of the composition.

Aqueous Phase

The aqueous phase comprises water, the foaming surfactants and the hydrophilic compounds that may be present. The composition according to the invention generally comprises an amount of water of less than or equal to 45% and preferably less than or equal to 30% of the total weight of the composition, this amount possibly ranging, for example, from 10% to 45% by weight and preferably from 10% to 30% by weight relative to the total weight of the composition.

According to one preferred embodiment of the invention, the composition of the invention contains at least one polyol (or polyhydric alcohol), which is generally present in the aqueous phase. Examples of polyols that may be mentioned include glycerol; glycols, for instance propylene glycol, butylene glycol, isoprene glycol and polyethylene glycols such as PEG-8; sorbitol; sugars such as glucose, fructose, maltose, lactose or sucrose; and mixtures thereof. When they are present, the amount of polyol(s) in the composition of the invention may range, for example, from 0.01% to 30% by weight, preferably from 2% to 20% by weight and better still from 5% to 15% by weight relative to the total weight of the composition.

The aqueous phase may conventionally contain, besides water and the polyols(s), one or more water-soluble solvents chosen from water-soluble lower alcohols. The term “lower alcohol” means an alcohol containing from 1 to 8 carbon atoms. Examples of lower alcohols that may be mentioned include ethanol, isopropanol and butanol, and mixtures thereof. When they are present in the composition of the invention, the water-soluble lower alcohol(s) may be in an amount ranging from 0.01% to 20% by weight and preferably from 0.1% to 10% by weight relative to the total weight of the composition, with the proviso that they do not harm either the foam quality or the stability of the composition.

Additives

The composition according to the invention may also contain any adjuvant or additive such as those usually used in the fields under consideration and especially in cosmetics or dermatology. Needless to say, a person skilled in the art will take care to select the optional additive(s) of the composition according to the invention such that the advantageous properties intrinsically associated with the composition in accordance with the invention are not, or are not substantially, adversely affected by the envisaged addition.

Among the conventional adjuvants that may be contained in the aqueous phase and/or in the oily phase of the emulsions in accordance with the invention (depending on the water-soluble or liposoluble nature of these adjuvants), mention may be made of preserving agents; sequestrants (EDTA); antioxidants; fragrances; dyestuffs such as soluble dyes, pigments and nacres; fillers with a matting, tensioning, bleaching or exfoliant effect; sunscreens; hydrophilic or lipophilic cosmetic or dermatological active agents, such as vitamins, antiseptics, anti-seborrhoeic agents, antimicrobial agents, for instance benzoyl peroxide, salicylic acid, triclosan, azeleic acid, niacin (vitamin PP), slimming agents, for instance caffeine, optical brighteners, electrolytes, agents having the effect of improving the cosmetic properties of the skin, or spherical or non-spherical, porous or non-porous solid particles of any size. The amounts of these various adjuvants are those conventionally used in the field under consideration, for example from 0.01% to 20% of the total weight of the composition. These adjuvants and the concentrations thereof should be such that they do not modify the property desired for the composition of the invention.

As fillers, mention may be made especially of silica.

The compositions may also contain hydrophilic or lipophilic, anionic, nonionic, cationic or amphoteric, thickening or dispersing polymers, provided that they do not affect the qualities of the emulsion or of the foam.

The emulsions according to the invention are preferably obtained via a phase inversion process as described above.

More particularly, a preferred preparation process comprises:
1) weighing out in a container all the constituents of the composition (except for the foaming surfactants, and heat-sensitive fillers and starting materials, if any),
2) homogenizing the mixture, for example using a Rayneri blender at 350 rpm, while heating by gradually increasing the temperature using a water bath, up to a temperature greater than or equal to the phase inversion temperature T2, i.e. until a transparent or translucent phase is obtained (microemulsion region or lamellar phase), and then until a more viscous white phase is obtained, which indicates that the inverse emulsion (W/o) has been obtained,
3) stopping the heating and continuing stirring until the emulsion has cooled to room temperature, passing through the phase inversion temperature. T, i.e. the temperature at which a fine O/W emulsion forms,
4) when the temperature has fallen below the phase inversion temperature region (T1), adding the optional particles (for example silica),
5) at about 45° C., adding the foaming surfactants,
6) at about 30° C., adding the heat-sensitive starting materials optionally present.

The temperature T1 corresponds to the formation of a bi-continuous microemulsion; the mixture is translucent and uniform; and the temperature T2 corresponds to the formation of a water-in-oil emulsion; the mixture becomes opaque white and thickens.

A stable O/W emulsion whose oil droplets are fine is obtained.

In the region of formation of a microemulsion (translucent mixture of micelles), the hydrophilic and hydrophobic interactions are equilibrated since the surfactant has a tendency to form both direct micelles and inverse micelles. By heating beyond this region, there is formation of a W/O emulsion (opaque white mixture) since the surfactant favours the formation of a water-in-oil emulsion. Next, on cooling below the phase inversion region, the emulsion becomes an O/W emulsion.

The compositions according to the invention are preferably in the form of more or less soft creams, and they may especially constitute cosmetic or dermatological compositions. They may be used on any keratin material such as the skin, the scalp, the hair, the eyelashes, the eyebrows, the nails or mucous membranes, especially as hygiene products, for example as cleansing products for the skin, mucous membranes and/or the hair, in particular as cleansing and/or makeup-removing products for the skin (of the face and/or the body), as shower products (two-in-one product), as shampoos or hair conditioners, as shaving products, as rinse-off masks, and as exfoliant products (also known as desquamating or scrubbing products) for either the face or the body or for the hands, after addition of exfoliant particles.

A subject of the invention is also the cosmetic use of the composition as defined above, as a skin cleansing and/or makeup-removing product, as a shower product, as a shampoo, as a hair conditioner, as a shaving product, as a rinse-off mask or as an exfoliant product.

Another subject of the invention is a process for cleansing a keratin material, such as the skin, the scalp, the hair, the eyelashes, the eyebrows, the nails or mucous membranes, wherein a composition as defined above is applied to the keratin material, and is rinsed off.

The keratin material is preferably the skin.

The compositions according to the invention are rinsed off after application.

The compositions according to the invention may be used, for example, in the following manner:

1) When the compositions according to the invention are gentle facial cleansing products, they may be used in the following manner:

the product is worked into a lather in the hands with water

the lather is applied to the face

the face is washed

it is rinsed with water.

Result: the skin is cleansed without being attacked.

2) When the compositions according to the invention are makeup-removing products, they may be used as indicated above, but they may also be applied dry to the face, and then massaged until satisfactory makeup removal is obtained, and rinsed off with water.

Result: makeup is removed from the skin without leaving an unpleasant greasy residue.

3) They may be used as two-in-one shower products in the usual manner for using shower products.

4) They may be used as shampoos and/or hair conditioners, as shaving products or as rinse-off masks in the usual manner for using these products.

5) They may be used as scrubbing products for either the face or the hands (when the composition contains exfoliant particles. The use consists in applying the product to the face, the hands or the body, rubbing for one or two minutes and then rinsing off. The skin is then left smooth, soft and scrubbed.

The examples described below were subjected to viscosity measurements to demonstrate their stability over time, and to tests to test their foam qualities.

Foam Performance:

For some of the examples, the foam performance of the compositions (foam qualities) were determined according to the protocol described below.

Before any use of the product, the hands are washed with household soap and then rinsed and dried thoroughly. The protocol followed is then as follows:

1—wet the hands by passing them under running water, and shake them three times to remove the excess water,

2—place 1 g of product in the palm of one of the hands,

3—work the product between the two palms for 10 seconds,

4—add 2 ml of water and work the product again for 10 seconds,

5—rinse the hands in water,

6—wipe them.

The criteria are evaluated at each step of the protocol followed, and they are graded on a scale from 0 to 10. It is considered that, for a given criterion, there is a difference in grade between two products when the difference between 2 grades is greater than or equal to 1.

step 3: evaluation of the covering power: the grade allocated is proportionately higher the less visible the skin of the hand when looking through the product spread thereon.

steps 4 and 5: evaluation of the foam quality
The volume of foam: the grade allocated is higher the greater the volume.
The size of the bubbles of which the foam is composed: the grade allocated is higher the larger the bubbles.
The density: consistency or persistence of the foam: the grade allocated is higher the greater the density.
Softness of the foam: the grade allocated is higher the softer the foam.

step 6: evaluation during rinsing: rinsing: the grade allocated is proportionately lower the greater the presence of a slippery film that is difficult to remove.

The evaluation panel consisted of 4 trained experts. The average of the 4 grades allows a comparison of the compositions according to each of the criteria.

The examples indicated below will allow the invention to be understood more clearly without, however, being limiting in nature. In these examples, the amounts indicated are weight percentages of active material (rather than amount of starting material). The compounds are cited as the chemical name or as the CTFA name.

The starting materials used in the examples were as follows, the amounts thereof having been adapted to the amount of active material in the examples:

(1) Eumulgin BA 10® sold by the company Cognis=oxyethylenated (10 OE) behenyl alcohol

(2) Ethyl Hexyl Stearate® sold by the company Cognis=octyl stearate

(3) Beaulight Shaa® sold by the company Sanyo=solution of sodium lauryl glycol carboxylate at an active material concentration of 29% by weight

(4) Oramix CG 110 sold by the company SEPPIC=solution of decyl glucoside at an active material concentration of 60% by weight

(5) Aerosil 200® sold by the company Degussa

(6) Genapol LRO B®=aqueous solution of sodium laureth sulfate, sold by Clariant, at an active material concentration of 70% by weight

(7) 2-Ethylhexyl palmitate® sold by the company Stéarinerie Dubois=octyl palmitate

(8) Genagen KB® sold by the company Clariant or Miritaine BB/FLA® sold by the company Rhodia or Empigen BB/LS® sold by the company Huntsman or Dehyton AB 30® sold by the company Cognis: solution of cocobetaine at an active material concentration of 30% by weight.

(9) AKYPO RLM 45 CA sold by the company KAO.

### EXAMPLE 1 ACCORDING TO THE INVENTION

| | Example 1 according to |
|---|---|
| Compositions | the invention |
| Beheneth-10 (1) | 4 |
| Octyl stearate (2) | 50.4 |
| Sodium lauryl glycol carboxylate (3) | 5.8 |
| Decyl glucoside (4) | 3 |
| Propyl paraben | 0.15 |
| Methyl paraben | 0.15 |
| Chlorhexidine digluconate | 0.25 |
| Glycerol | 6.5 |
| Silica (5) | 2 |
| Ethanol | 2 |
| Sodium citrate | 0.025 (as pH 6.9) |
| Deionized water | qs 100% |
| Appearance | unctuous white cream |
| | that does not flow |
| Viscosity (Pa · s) after 24 hours at | 2.5 Pa · s |
| room temperature (25° C.) after 10 | |
| minutes of rotation of the spindle. | |

Table of foam qualities

| | Example 1 |
|---|---|
| | according to the |
| | invention |
| Initiation | 7.5 |
| Mixing with water | 10.0 |
| Homogeneity | 10.0 |
| Covering | 6.3 |
| Foam volume + 2 ml of water (step 4) | 3.4 |
| Bubble size + 2 ml of water (step 4) | 3.6 |
| Density + 2 ml of water (step 4) | 4.4 |
| Foam volume + 4 ml of water (step 5) | 5.0 |
| Bubble size + 4 ml of water (step 5) | 4.1 |
| Density + 4 ml of water (step 5) | 4.1 |
| Softness | 6.5 |
| Rinsing | 7.6 |

These results show that the composition according to the invention gives a foam that starts well, is homogeneous, has good density and rinses off well.

### EXAMPLE 2 ACCORDING TO THE INVENTION AND COMPARATIVE EXAMPLE 1

| | Comparative | Example 2 of the |
|---|---|---|
| Composition | Example 1 | invention |
| Beheneth-10 (1) | 4 | 4 |
| Octyl stearate (2) | 50.4 | 50.4 |
| Sodium lauryl glycol carboxylate | — | 5.8 |
| (3) | | |
| Decyl glucoside (4) | 3 | 3 |
| Sodium laureth sulfate (6) | 5.8 | — |
| Propyl paraben | 0.15 | 0.15 |
| Methyl paraben | 0.15 | 0.15 |
| Chlorhexidine digluconate | 0.25 | 0.25 |
| Glycerol | 6.5 | 6.5 |
| Silica (5) | 2 | 2 |
| Ethanol | 2 | 2 |
| Sodium citrate | 0.025 | 0.025 |
| | (qs pH 6.9) | (qs pH 6.9) |
| Deionized water | qs 100% | qs 100% |
| Appearance | unctuous | unctuous |
| | white cream | white cream |
| | that does | that does |
| | not flow | not flow |
| pH | 6.9 | 6.9 |
| Viscosity (Pa · s) after 24 hours | 3.7 | 6 |
| at room temperature (25° C.); | | |
| after 10 minutes of rotation of | | |
| the spindle M3 | | |

The comparison of the foam qualities in the table below shows that the composition containing Beaulight Shaa has better performance in terms of foam initiation, the covering effect, the volume and the density of foam compared with the comparative example containing a standard surfactant such as sodium lauryl ether sulfate.

Table of foam qualities

| | | Example 2 |
|---|---|---|
| | Comparative | according to the |
| | Example 1 | invention |
| Initiation | 2.5 | 7.5 |
| Mixing with water | 10 | 10.0 |
| Homogeneity | 10 | 10.0 |
| Covering | 3 | 6.3 |
| Foam volume + 2 ml | 2 | 3.4 |
| Bubble size + 2 ml | 3.5 | 3.6 |
| Density + 2 ml | 2.5 | 4.4 |
| Foam volume + 4 ml | 3 | 5.0 |
| Bubble size + 4 ml | 4.6 | 4.1 |
| Density + 4 ml | 1.3 | 4.1 |
| Softness | 6.5 | 6.5 |
| Rinsing | 6 | 7.6 |

### EXAMPLES 3 AND 4 ACCORDING TO THE INVENTION

| | Example 3 | |
|---|---|---|
| | (foaming makeup | Example 4 |
| Composition | remover) | (foaming) |
| Beheneth-10 (1) | 4 | 4 |
| Octyl palmitate (7) | 40 | — |
| Octyl stearate (2) | — | 50.4 |
| PEG-6 capric/caprylic | 1.55 | — |
| glycerides | | |
| Sodium lauryl glycol | 2.9 | 3.8 |
| carboxylate (3) | | |
| Decyl glucoside (4) | 7.2 | 3 |
| Cocobetaine (8) | 0.9 | 2.1 |
| Silica (5) | 2 | 2 |
| Isononyl isononanoate | 12.4 | — |
| Propyl paraben | 0.15 | 0.15 |
| Methyl paraben | 0.15 | 0.15 |
| Chlorhexidine | 0.25 | — |
| digluconate | | |
| Glycerol | 6.5 | 6.5 |
| Ethanol | 2 | — |
| Deionized water | qs 100% | qs 100% |
| Appearance | unctuous white | unctuous |
| | cream that does | white cream |
| | not flow | that does not |
| | | flow |
| Viscosity (Pa · s) after | 3.4 | 6 |
| 24 hours at room | | |
| temperature; 25° C.; after | | |
| t10 minutes of rotation | | |
| of the spindle M3. | | |
| Makeup-removing power | 73% | not measured |

### EXAMPLE 5 ACCORDING TO THE INVENTION AND COMPARATIVE EXAMPLE 2

| | Example 5 | |
|---|---|---|
| | (foaming makeup | Comparative |
| Composition | remover) | Example 2 |
| Beheneth-10 (1) | 4 | 4 |
| Octyl palmitate (8) | 30.4 | 30.4 |
| Liquid petroleum jelly | 20 | 20 |
| (mineral oil) | | |
| Sodium lauryl glycol | 20 | — |
| carboxylate (3) | | |
| Laureth-5 carboxylic | | 20 |
| acid | | |
| Propyl paraben | 0.15 | 0.15 |
| Methyl paraben | 0.15 | 0.15 |
| Silica (Aerosil 200 ® from | 2 | 2 |
| Degussa) | | |
| Isononyl isononanoate | 12.4 | 12.4 |
| Propyl paraben | 0.15 | 0.15 |
| Glycerol | 6.5 | 6.5 |
| Sodium hexametaphosphate | 2 | 2 |
| Ethanol | 2 | 2 |
| Deionized water | qs 100% | qs 100% |
| Appearance | unctuous white | fluid |
| | cream that does | composition |
| | not flow | that is |
| | | dephased |
| Viscosity (Pa · s) after 24 | 3.6 | Impossible to |
| hours at room temperature; | | get because |
| 25° C.; after t10 minutes of | | the product |
| rotation of the spindle M3. | | is dephased |
| pH | 6.0 | Impossible to |
| | | get because |
| | | the product |
| | | is dephased |
| Properties | foams well | does not |
| | | foam |

The comparative example 2 shows that the aim of the invention is not obtained when a carboxylic surfactant other than those of formula (I) is used.

The above written description of the invention provides a manner and process of making and using it such that any person skilled in this art is enabled to make and use the same, this enablement being provided in particular for the subject matter of the appended claims, which make up a part of the original description and including a foaming composition for topical application in the form of an oil-in-water emulsion, comprising an oily phase dispersed in an aqueous phase, wherein:

the size of the droplets of the oily phase D[4,3] is less than or equal to 4 μm,

the oily phase (A) is present in an amount of at least 30% by weight relative to the total weight of the composition,

and in that the composition contains:

an emulsifying system (B) with an HLB value ranging from 8 to 18, present in an amount of at least 2% by weight relative to the total weight of the composition,

a foaming system (C) comprising at least one anionic surfactant chosen from alkyl glycol carboxylic acids and salts thereof, of formula (I) below:
R₁—CHOH—CH₂—O—COO⁻X⁺ (I)
in which R₁ denotes a saturated or unsaturated, linear or branched alkyl radical containing from 8 to 30 carbon atoms, and X denotes hydrogen or a mineral or organic cation,

the oily phase (A)/foaming system (C) weight ratio ranging from 1.5 to 12.

As used above, the phrases “selected from the group consisting of,” “chosen from,” and the like include mixtures of the specified materials. Terms such as “contain(s)” and the like as used herein are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A foaming composition in the form of an oil-in-water emulsion, comprising an oily phase dispersed in an aqueous phase, wherein:
the size of the droplets of the oily phase D[4,3] is less than or equal to 4 μm,
the oily phase (A) is present in an amount of at least 30% by weight relative to the total weight of the composition,
wherein the composition comprises:
an emulsifying system (B) with an HLB value of 8-18, present in an amount of at least 2% by weight relative to the total weight of the composition,
a foaming system (C) comprising at least one anionic surfactant chosen from alkyl glycol carboxylic acids of formula (I) and salts thereof:
R₁—CHOH—CH₂—O—COO⁻X⁺ (I)
in which R₁ denotes a saturated or unsaturated, linear or branched alkyl radical having 8 to 30 carbon atoms, and X denotes hydrogen or a mineral or organic cation, and
wherein the oily phase (A)/foaming system (C) weight ratio is 1.5-12.

2. The composition according to claim 1, prepared by phase inversion emulsification.

3. The composition according to claim 1, wherein the mean size of the droplets of oily phase D[4,3] is 0.09 μm-4 μm.

4. The composition according to claim 1, comprising at least one compound of formula (I) in which R₁ denotes a saturated or unsaturated, linear or branched alkyl radical having 8 to 18 carbon atoms.

5. The composition according to claim 1, comprising sodium lauryl glycol carboxylate, and/or its acid form.

6. The composition according to claim 1, wherein the foaming system further comprises one or more foaming surfactants chosen from alkyl polyglucosides, betaine derivatives, alkyl phosphates and alkyl ether sulfates, and mixtures thereof.

7. The composition according to claim 1, wherein the amount of foaming system is 0.5%-20% by weight relative to the total weight of the composition.

8. The composition according to claim 1, wherein the oily phase (A)/foaming system (C) weight ratio is 4-10.

9. The composition according to claim 1, wherein the emulsifying system comprises at least one chosen from ethoxylated fatty alcohols, ethoxylated fatty acids, partial glycerides of ethoxylated fatty acids, triglycerides of polyglycerolated fatty acids and ethoxylated derivatives thereof, and mixtures thereof.

10. The composition according to claim 1, wherein the emulsifying system comprises at least one chosen from the products of addition of ethylene oxide with lauryl alcohol; the products of addition of ethylene oxide with behenyl alcohol; the products of addition of ethylene oxide with cetearyl alcohol; the products of addition of ethylene oxide with cetyl alcohol; the products of addition of ethylene oxide with stearyl alcohol; the products of addition of ethylene oxide with isostearyl alcohol; the products of addition of ethylene oxide with lauric acid, palmitic acid, stearic acid or behenic acid, and mixtures thereof.

11. The composition according to claim 1, wherein the emulsifying system comprises one or more coemulsifiers chosen from fatty alcohols containing 8 to 30 carbon atoms; fatty acids containing 8 to 30 carbon atoms; fatty esters of glycerol; oxyethylenated derivatives thereof containing 2 to 8 ethylene oxide groups, and mixtures thereof.

12. The composition according to claim 1, wherein the amount of emulsifying system is 2% to 20% by weight relative to the total weight of the composition.

13. The composition according to claim 1, wherein the emulsifying system (B)/oily phase (A) ratio is 0.04 to 0.2.

14. The composition according to claim 1, wherein the amount of oily phase ranges from 30% to 70% by weight relative to the total weight of the composition.

15. The composition according to claim 1, wherein the oily phase comprises one or more oils with a molecular weight of greater than or equal to 360 g/mol.

16. The composition according to claim 1, wherein the oily phase comprises at least one oil chosen from liquid petroleum jelly, 2-ethylhexyl palmitate and cetyl 2-ethylhexanoate, and mixtures thereof.

17. The composition according to claim 1, wherein it comprises an amount of water of less than or equal to 45% of the total weight of the composition.

18. The composition according to claim 1, wherein said composition is a skin cleansing and/or makeup-removing product, a shower product, a shampoo or hair conditioner, a shaving product, a rinse-off mask or an exfoliant product.

19. A process for cleansing a keratin material, wherein a composition according to claim 1 is applied to the keratin material, and is rinsed off.
